(19) United States
(12) Patent Application Publication
(10) Pub. No.: US 2008/0304266 A1
(43) Pub. Date: Dec. 11, 2008

(54) Light source apparatus

(75) Inventors: Takehiko Iguchi, Hyogo (JP); Hitoshi Nakabayashi, Hyogo (JP); Katsuoki Miyasu, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/153,647

(22) Filed: May 22, 2008

(30) Foreign Application Priority Data
Jun. 6, 2007 (JP) 2007-150542

(51) Int. Cl. F21V 7/00; F21V 21/00; F21V 21/26

(52) U.S. Cl. 362/247; 362/249; 362/269

(57) ABSTRACT

A light source apparatus comprises a reflection mirror; a first support member which supports a first mouthpiece of a xenon lamp; a second support member which supports a second mouthpiece of the xenon lamp; a support plate which supports the reflection mirror and the first and second mouthpieces; wherein the first lamp support member has a lamp support portion, and a support stand which is supported by the support plate and supports the lamp support portion, and wherein the lamp support portion has a position changing portion capable of changing the first support member between two positions in an optical direction.

### CROSS-REFERENCES TO RELATED APPLICATION

The disclosure of Japanese Patent Application No. 2007-150542, filed Jun. 6, 2007, including its specification, claims and drawings, is incorporated herein by reference in its entirety.

### TECHNICAL FIELD

Described herein is a light source apparatus, and especially, a light source apparatus used as a light source of a projector.

### BACKGROUND

In Japanese Laid Open Patent No. 2001-319502, a light source apparatus which uses a xenon lamp as a light source of a projector is disclosed. As in Japanese Laid Patent No. 2001-319502, FIG. 13 shows a partial front cross sectional view of a lamp of a conventional light source apparatus 100, in which a short arc type xenon lamp 101 is provided.

In the figure, xenon gas whose pressure becomes 2-8 MPa at time of lighting, is enclosed in a spherical bulb 111 of the short arc type xenon lamp 101, and a pair of electrodes 112 facing each other is arranged inside thereof. A pair of sealing portions 113 in which the respective electrodes 112 are buried is provided in both ends of the bulb 111, and mouthpieces 114 and 115 are provided on the respective sealing portions 113. The pair of electrodes 112 is connected with a power supply (not shown), and the xenon lamp 101 is turned on when rated lighting electric power of 2-7 kW is inputted therein. At time of lighting of the xenon lamp 101, since a distance between the electrodes 112 which face each other is short (close to each other), a diameter of an arc is short so that a small point light source may be formed.

One of the mouthpieces 114 which are arranged at the both ends of the xenon lamp 101 is supported by a first lamp support portion 102, and on the other hand, the mouthpiece 115 is supported by a second lamp support portion 103. Reflection mirrors 104 and 105 are arranged so that the bulb 111 of the xenon lamp 101 may be provided between the mouthpieces 114 and 115. The reflection mirrors 104 and 105 are provided so that focal points thereof and a focal point (point light source) of the xenon lamp 101 may be matched each other. The first lamp support portion 102, the second lamp support portion 103, and the reflection mirrors 104 and 105 are supported on a support plate 106. The support plate 106 is installed in a projector (not shown). In addition, as shown in the figure, a direction of a central axis of the pair of electrodes 112 of the xenon lamp 101 is shown as an X axis direction, a direction which is perpendicular to the central axis of the electrodes 112 and in which the first lamp support member 102 which supports the xenon lamp 101 extends, is shown as a Y axis direction, and a direction which is perpendicular to the X axis direction and the Y axis direction, respectively, is shown as a Z axis direction.

However, in the above described conventional light source apparatus, a different length of xenon lamp in the optical axis and/or a different size thereof in a direction perpendicular to the optical axis may not be used in a light source apparatus. In addition, when the different length or size of xenon lamp is used, it is necessary to compensate positioning thereof so as not to shift the focal point of the xenon lamp from that of reflection mirrors.

### SUMMARY

Described herein is a light source apparatus capable of using a xenon lamp having a different length in the optical axis direction and/or size in a direction perpendicular to the optical direction.

In order to solve the above-mentioned subject, the present light source apparatus comprises a reflection mirror, a first support member which supports a first mouthpiece of a xenon lamp, a second support member which supports a second mouthpiece of the xenon lamp, a support plate which supports the reflection mirror and the first and second mouthpieces, wherein the first lamp support member has a lamp support portion, and a support stand which is supported by the support plate and supports the lamp support portion, and wherein the lamp support portion has a position changing portion capable of changing the first support member between two positions in an optical direction. Thus, since the lamp support portion has the position change portion in which the position thereof can be switched between two positions in the optical axis direction, a different length of the xenon lamp can be supported thereby.

In the light source apparatus, the lamp support portion may have a lamp placement portion, an axis portion which supports the lamp placement portion and curves or bends in the optical axis direction; and a positioning stand which supports the axis portion and is supported by the support stand, in which a direction of the positioning stand is capable of being rotated in the optical axis direction by 180 degrees by the position changing portion, and the positioning stand is capable of being supported by the support stand. Thus, since the axis portion of the lamp support portion is bent in the optical axis direction, by rotating the optical axis of the positioning stand of the lamp support portion by 180 degrees, the lamp placement portion provided on the tip of the axis portion can be arranged in a position shifted in the optical axis direction so that it is possible to support a different length of xenon lamp.

Also, in the light source apparatus, the lamp support portion may have a lamp placement portion, an axis portion which supports the lamp placement portion, and a positioning stand which supports the axis portion at a position shifted in the optical axis direction, and a direction of the positioning stand is capable of being rotated in the optical axis direction by 180 degrees by the position changing portion and the positioning stand is capable of being supported by the support stand. Thus, since the positioning stand of the lamp support portion which supports the axis portion provided so as to shift in the optical axis direction, by rotating the optical axis of the positioning stand by 180 degrees, the lamp placement portion provided on the tip of the axis portion can be arranged in a position shifted in the direction of the optical axis, so that a different length of a xenon lamp can be supported.

Further, in the light source apparatus, the lamp support portion may have a lamp placement portion, an axis portion which supports the lamp placement portion, bends in the optical axis direction, and has flat portions or a projection portion, and the support stand may have a hole in which the axis portion having the flat portions or the projection is inserted, and a direction of the positioning stand is capable of being rotated in the optical axis direction by 180 degrees by the position changing portion and the positioning stand is capable of being supported by the support stand. Thus, since the axis portion of the lamp support portion is bent in the optical axis direction, by rotating the optical axis of the axis portion by 180 degrees, and making it supported by the support stand, the lamp placement portion provided on the tip of the axis portion can be arranged in the position shifted in the optical axis direction, so that a different length of a xenon lamp can be supported.

Still further, in the light source apparatus, the lamp support portion may have two lamp placement portions facing in directions which are opposite to each other, and are perpendicular to an optical axis, an axis portion which supports the two lamp placement portions, wherein the support stand has a stopper stand which restricts rotation of the axis portion and a hinge which rotatably supports the axis portion on a face perpendicular to the optical axis, and wherein the axis portion is capable of being rotated with respect to the hinge by the position changing portion so that a direction of the axis portion is changed in the optical axis direction. Thus, by rotating the axis portion of the lamp support portion on a face perpendicular to the optical axis, the lamp support portion is arranged towards a counter direction on the optical axis direction line, when the lamp placement portion in one side is rotated to another side, the lamp placement portion can be located at a position sifted in the optical axis direction whereby a different length of the xenon lamp 2 can be supported.

Moreover, in the light source apparatus, the support stand may have a stopper stand which restricts rotation of the lamp support portion and a hinge which rotatably supports the lamp support portion on a face perpendicular to the optical axis, and the lamp support portion is capable of being rotated with respect to the hinge by the position changing portion so that a direction of the lamp support portion is changed in the optical axis direction. Thus, since the two lamp placement portions are arranged apart from each other in the optical axis direction, by rotating the optical axis of the positioning stand of the lamp support portion by 180 degrees, the lamp placement portion in one side is rotated to another side so that the lamp placement portion can be located at a position sifted in the optical axis direction, whereby a different length of xenon lamp 2 can be supported.

In the light source apparatus, opening angles of the two lamp placement portions are different from each other. Thus, since the opening angle of the lamp placement portion which supports a short length of a xenon lamp is smaller than that of opening angle of the lamp placement portion in another side, which supports a long xenon lamp, it is possible to prevent the focal point of the xenon lamp from shifting from the focal point of the reflection mirrors in a direction perpendicular to the optical axis.

In the light source apparatus, the support stand may have a stopper stand which restricts rotation of the lamp support portion and a hinge which rotatably supports the lamp support portion on a face perpendicular to the optical axis, and wherein the lamp support portion is capable of being rotated with respect to the hinge by the position changing portion so that a direction of the lamp support portion is changed in the optical axis direction. Thus, by rotating the inclined lamp support portion around the axis horizontal to the optical axis, the lamp support portion can be arranged in the position at which the lamp support portion is inclined in the counter direction to the above-mentioned inclination direction and is shifted in the optical axis direction, so that a different length of a xenon lamp can be supported.

### BRIEF DESCRIPTION OF THE DRAWINGS

Other features and advantages of the present light source apparatus will be apparent from the ensuing description, taken in conjunction with the accompanying drawings, in which:

FIG. 1 is a front cross sectional view showing the structure of a light source apparatus 1 having a first lamp support member 5 according to an embodiment of the present invention;

FIG. 2 is an enlarged view of the first lamp support member 5 according to the embodiment shown in FIG. 1;

FIG. 3 is a partial front cross sectional view of a light source apparatus 1, wherein a lamp support portions 51 of a first lamp support member 5 is rotated by 180 degrees around the Y axis with respect to a support stand 52 from the state of the light apparatus 1 shown in FIG. 1;

FIGS. 4A and 4B show enlarged views of lamp placement portions 5111 and 5112 of a first lamp support member 5 respectively according to a second embodiment;

FIG. 5 is a perspective view of a first lamp support member 5 according to a third embodiment;

FIG. 6 is a perspective view of a first lamp support member 5 according to a fourth embodiment, in which a lamp support portion 51 is pulled out from a support stand 52;

FIGS. 7A and 7B are enlarged views of a first lamp support member 5 according to a fifth embodiment;

FIG. 8 is a perspective view of a first lamp support member 5 according to this embodiment;

FIG. 9 is a perspective view of a first lamp support member 5 according to this embodiment;

FIG. 10A is a side elevational view of a first lamp support member 5 according to the embodiment;

FIG. 10B is a side elevational view of a first lamp support member 5, in which a lamp support portions 51 shown in FIG. 10A is rotated by 180 degrees around the Z axis;

FIG. 11A is a perspective view of a first lamp support member 5 according to this embodiment;

FIG. 11B is a front view of a first lamp support member 5 shown in the FIG. 11A;

FIG. 11C is a front view of a first lamp support member 5 in which a lamp support portions 51 shown in the FIG. 11A is rotated by 180 degrees around the Y axis;

FIG. 12A is a perspective view of a first lamp support member 5 according to the embodiment;

FIG. 12B is a perspective view of a first lamp support member 5 in which a lamp support portion 55 shown in FIG. 12A is rotated around the Z axis;

FIG. 12C is a front view showing a rotation operation of a lamp support portion 55 of a first lamp support member 5 shown in an FIGS. 12A and 12B; and

FIG. 13 shows a partial cross sectional view of a lamp of a conventional light source apparatus 100, in which a short arc type xenon lamp is used.

### DESCRIPTION

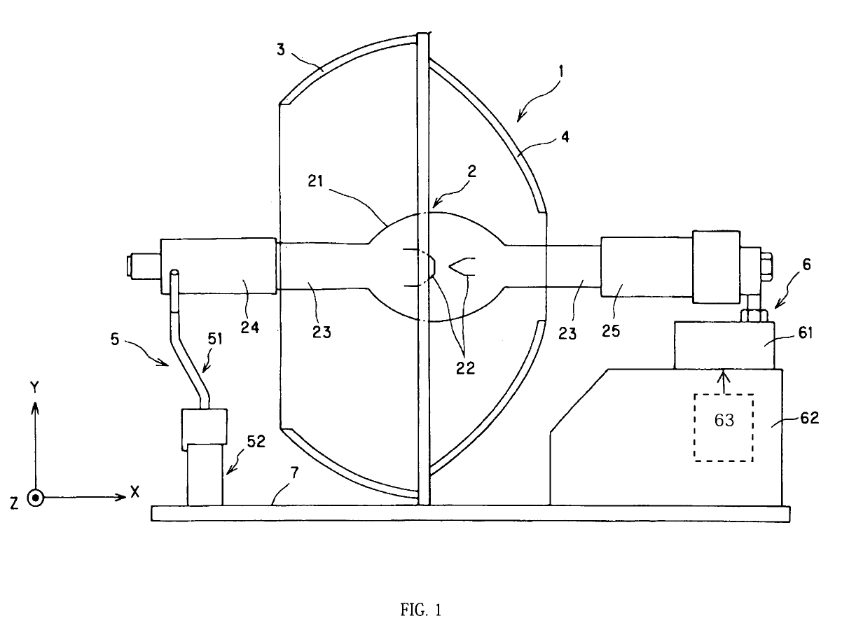

A first lamp support member 5 according to a first embodiment used for a light source apparatus 1 will be described, referring to FIGS. 1-3.

FIG. 1 is a partial cross sectional view of the light source apparatus 1 having a lamp support member 5 according to the embodiment.

As shown in the figure, the light source apparatus 1 includes a short arc type xenon lamp 2 having a spherical bulb 21, a pair of electrodes 22 which is provided in the bulb 21, and a pair of sealing portions 23. Mouthpieces 24 and 25 of the xenon lamp 2 are provided on the respective sealing portions 23. Reflection mirrors 3 and 4 are arranged so that the bulb 21 of the xenon lamp 2 may be surrounded by and arranged between the mouthpiece 24 and 25. A first lamp support member 5 supports the mouthpiece 24, and a second lamp support member 6 supports the mouthpiece 25. A lamp support portion 61 is capable of moving in the optical axis direction by an adjusting mechanism 63, when a different length of the xenon lamp 2 is used. A support stand 62 supports the lamp support portion 61 and is fixed to a support plate 7. The support plate 7 supports the reflection mirrors 3 and 4, and the first and second lamp support members 5 and 6.

Xenon gas is enclosed inside the spherical bulb 21 of the xenon lamp 2 so that the gas pressure at time of lamp lighting may be set to 2-8 MPa, and the pair of electrodes 22 is arranged so as to face each other. The pair of sealing portions 23 in which the respective electrodes 22 are buried is provided in the both ends of the bulb 21, and the mouthpieces 24 and 25 are provided on the respective sealing portions 23. The pair of electrodes 22 is connected with a power supply (not shown), and 2-7 kW of rated lighting electric power is inputted thereto, so that the xenon lamp 2 is turned on. At time of lighting of the xenon lamp 2, since the pair of electrodes 22 which face each other has a short distance therebetween (close to each other), the diameter of an arc is small so that a small point light source is formed between the electrodes 22. In addition, as shown in the figure, a direction of the central axis (the optical axis direction) of the pair of electrodes 22 of the xenon lamp 2 is shown as an X axis direction, a direction which is perpendicular to the central axis direction (optical axis direction) of the electrodes 22 and in which the first lamp support member 5 for supporting the xenon lamp 2 extends, is shown as a Y axis direction, and a direction which is perpendicular to the X axis direction and the Y axis direction is shown as a Z axis direction.

As shown in FIG. 1, the pair of mouthpieces 24 and 25 is arranged in the both sides of the xenon lamp 2, and the first lamp support member 5 supports the mouthpiece 24, and the second lamp support member 6 supports the mouthpiece 25. The reflection mirrors 3 and 4 are arranged between the mouthpieces 24 and 25 so as to surround the bulb 21 of the xenon lamp 2. The reflection mirrors 3 and 4 are provided so that focal points thereof and a focal point (point light source) of the xenon lamp 2 may match each other. The first lamp support member 5, the second lamp support member 6, and the reflection mirrors 3 and 4 are supported on one support plate 7. The support plate 7 is installed in a projector (not shown).

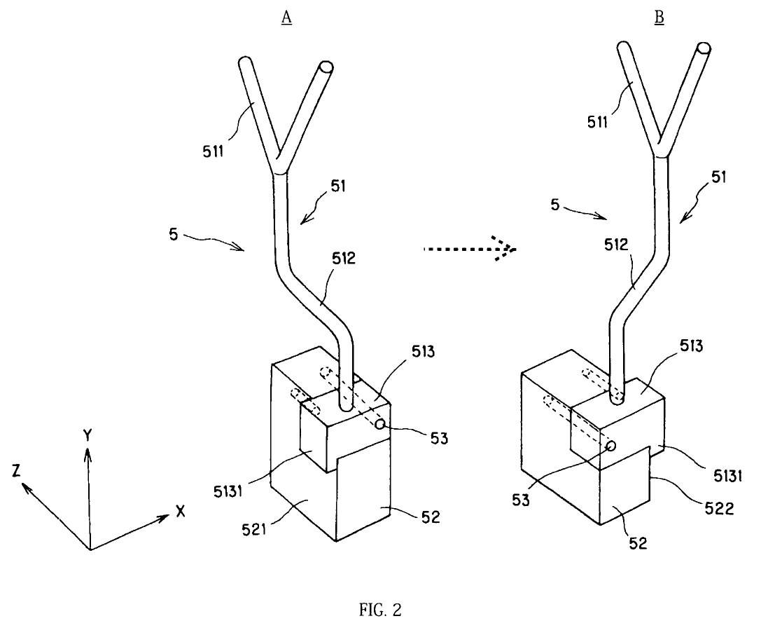

FIG. 2 is an enlarged view of the first lamp support member 5 according to the embodiment shown in FIG. 1. In FIG. 2, A is a perspective view of the first lamp support member 5. In FIG. 2, B is a perspective view of the first lamp support member 5 shown in A of FIG. 2, in which the lamp support portion 51 is rotated by 180 degrees with respect to the Y axis, and the first lamp support member 5 is supported by the support stand 52.

In these figures, the lamp support portion 51 is shown, and the one of the mouthpieces 24 of the xenon lamp 2 is placed on a V-shaped portion of a lamp placement portion 511. An axis portion 512 supports the lamp placement portion 511 and is bent in the optical axis direction. A positioning stand 513 supports the axis portion 512 and is supported by the support stand 52. A projection portion 5131 projects in the Y axis direction from one end of the positioning stand 513 in the X axis direction. The support stand 52 supports the positioning stand 513 and is supported by the support plate 7. A first face 521 is parallel to the Y and Z axes of the support stand 52, and a second face 522 is also parallel to the Y and Z axes of the support stand 52. A fixing member 53 fixes the positioning stand 513 to the support stand 52.

As shown in A of FIG. 2, the first lamp support member 5 is made up of the lamp support portion 51 and the support stand 52. The lamp support portion 51 is made up of the lamp placement portion 511, the axis portion 512, and the positioning stand 513. The positioning stand 513 is L-shaped. The positioning stand 513 has the projection portion 5131 which engages the support stand 52. The positioning stand 513 is placed on the support stand 52, and an inner face of side the projection portion 5131 of the positioning stand 513 and the first face 521 of the support stand 52 are made in contact with each other. The positioning stand 513 is fixed to the support stand 52 by the fixing member 53. The axis portion 512 which extends from the positioning stand 513 in the Y axis direction, has the lamp placement portion 511 on the tip of the axis portion 512. The axis portion 512 is bent so that the lamp placement portion 511 provided on the tip of the axis portion 512 may be shifted in the X axis direction.

In A of FIG. 2, the lamp placement portion 511 is arranged in the first position of the optical axis direction. When changing the position of the lamp placement portion 511 in the optical axis direction, the fixing member 53 is removed, and then the positioning stand 513 which supports the axis portion 512 of the lamp support portion 51, is rotated by 180 degrees with respect to the Y axis. As shown in B of FIG. 2, the inner side face of the projection portion 5131 of the positioning stand 513 engages the second face 522 of the support stand 52, so that the lamp placement portion 511 is arranged in the second position in the optical axis direction by fixing the positioning stand 513 to the support stand 52 by the fixing member 53. That is, the lamp placement portion 511 provided on the tip of the axis portion 512 is arranged in a position which is shifted in the X axis direction, by rotating the positioning stand 513, which supports the axis portion 512, around the Y axis by 180 degrees, since the axis portion 512 is bent (curved) in the X axis direction.

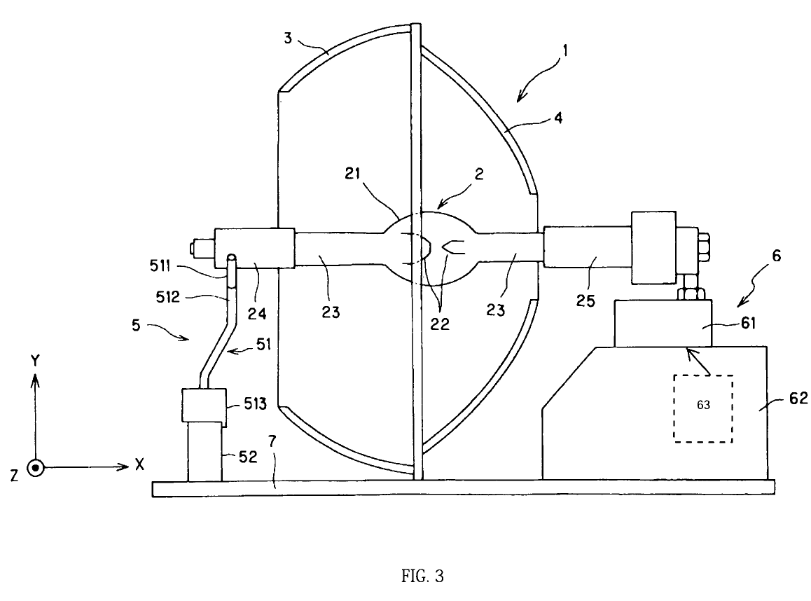

FIG. 3 is a partial front cross sectional view of the of the light source apparatus 1, wherein the lamp support portions 51 of the first lamp support member 5 is rotated by 180 degrees around the Y axis with respect to the support stand 52 shown in B of FIG. 2. As shown in this figure, the xenon lamp 2 with a length shorter than that shown in FIG. 1 in the optical axis direction (X axis direction) can be used. Under the circumstances, the lamp support portion 61 which can be adjusted in the X axis direction of the second lamp support member 6 by the adjusting mechanism 63 is moved to the first lamp support member 5 side on the X axis. When the xenon lamp 2 with the short length in the optical axis direction is attached to the light source apparatus 1, first, the lamp support portion 61 is arranged so that the state shown in A of FIG. 2 is changed to the state shown in B of FIG. 2.

As shown in FIG. 3, after the arrangement, the other mouthpiece 25 of the xenon lamp 2 is supported by and fixed to the lamp support portion 61 of the second lamp support member 6, and then, the lamp support portion 61 is moved to the first lamp support member 5 side on an X axis line by the adjusting mechanism 63 so that the focal point of the xenon lamp 2 and that of the reflection mirrors 3 and 4 may be in agreement. After the movement, the mouthpiece 24 of the xenon lamp 2 is placed on the lamp placement portion 511 of the first lamp support portion 5.

In the light source apparatus 1 according to the embodiment, when the xenon lamp which is short in the optical axis direction is used, instead of the xenon lamp 2 which is long in the optical axis direction, the lamp placement portion 511 of the first lamp support member 5 is moved to the second position located in the second lamp support member 6 side from the first position in the X axis direction. Moreover, since the lamp support portion 61 of the second lamp support member 6 is moved to the first lamp support member 5 side in the X axis direction by the adjusting member, so that the xenon lamp 2 is attached to the light source apparatus 1, even if the xenon lamp 2 with a different length is used, the focal position of the xenon lamp 2 is not shifted, so that the focal point of the reflection mirrors 3 and 4 and that of the xenon lamp 2 can be made easily in agreement.

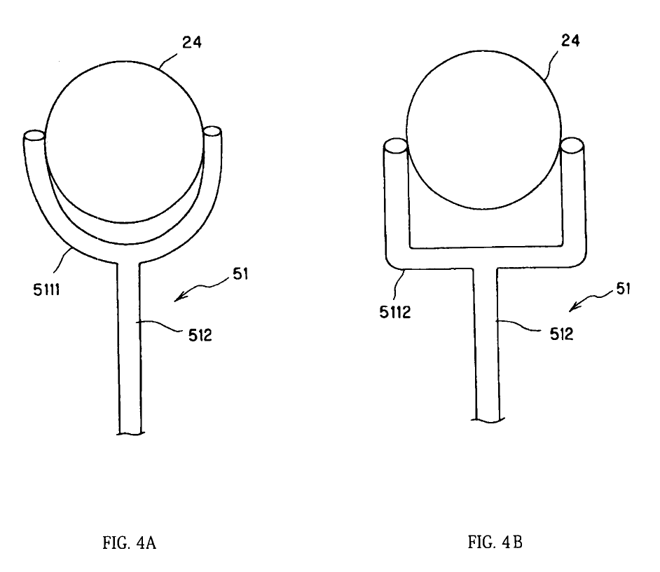

A first lamp support member 5 according to a second embodiment used for a light source apparatus 1 is described, referring to FIG. 4.

FIGS. 4A and 4B are enlarged views of a lamp placement portion of the first lamp support member 5 according to the embodiment. In these figures, a lamp placement portion 5111 is U-shaped and is provided on an axis portion 512, and a lamp placement portion 5112 is formed in shape of a “ [symbol] ” symbol and is provided on the axis portion 512. The other structural elements in the figures having the same reference numerals as those shown in FIG. 2 correspond to the same structural elements in FIG. 2, so that explanation thereof is omitted. As in the U-shaped lamp placement portion 5111 shown in FIG. 4A, or as in the [symbol] -shaped lamp placement portion 5112 shown in FIG. 4B, the lamp placement portion is not limited to the V shaped lamp placement portion 511 shown in FIG. 2 of the first embodiment, as long as the lamp placement portion has the structure capable of supporting one of the mouthpieces 24 of the xenon lamp 2 (at two points thereof).

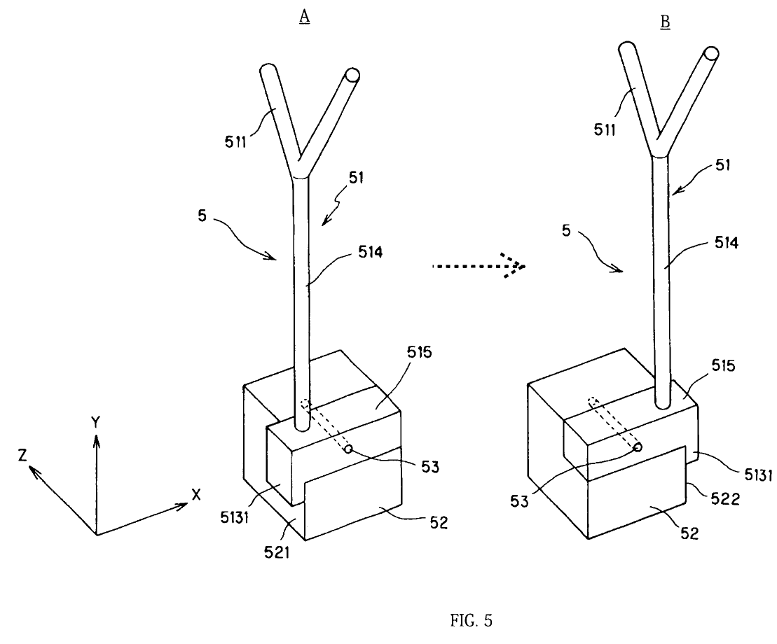

Next, a first lamp support member 5 according to a third embodiment used for a light source apparatus 1 is described referring to FIG. 5.

A of FIG. 5 is a perspective view of the first lamp support member 5 according to the embodiment. B of FIG. 5 is a perspective view of the first lamp support member 5, in which a lamp support portions 51 of the first lamp support member 5 shown in A of FIG. 5 is rotated by 180 degrees around the Y axis, so as to be supported by a support stand 52. In the figure, an axis portion 514 supports a lamp placement portion 511, and a positioning stand 515 is provided, shifting in the optical axis direction, supports the axis portion 514 and is supported by the support stand 52. In addition, since the other structural elements in the figure having the same reference numerals as those shown in FIG. 2 correspond to the same structural elements in FIG. 2, explanation thereof is omitted.

As shown in A of FIG. 5, in the first lamp support member 5 according to this embodiment, the axis portion 514 is provided, shifting in the optical axis direction on the positioning stand 515, and is supported thereby (at, for example, a position near a projection portion 5131 of the positioning stand 515). An inner portion of the projection portion 5131 of the positioning stand 515 of the lamp support portion 51 engages a first face 521 of the support stand 52, and the positioning stand 515 is fixed to the support stand 52 by a fixing member 53. Therefore, the lamp placement portion 511 is arranged in the first position in the optical axis direction.

When changing the position of the lamp placement portion 511 in the optical axis direction, in A of FIG. 5, the fixing member 53 is removed and the positioning stand 515 is rotated around the Y axis by 180 degrees, and then the projection portion 5131 of the positioning stand 515 is arranged so as to engage a second face 522 of the support stand 52. When the positioning stand 515 is fixed to the support stand 52 by the fixing member 53, as shown in B of FIG. 5, the lamp placement portion 511 is arranged in the second position shifted in the optical axis direction. That is, by rotating the positioning stand 515, which is shifted in the optical axis direction and supports the axis portion 514, around the Y axis by 180 degrees, the lamp placement portion 511 provided on the tip of the axis portion 514 is arranged at a position which is shifted in the X axis direction, so that the xenon lamp 2 with a different length can be supported.

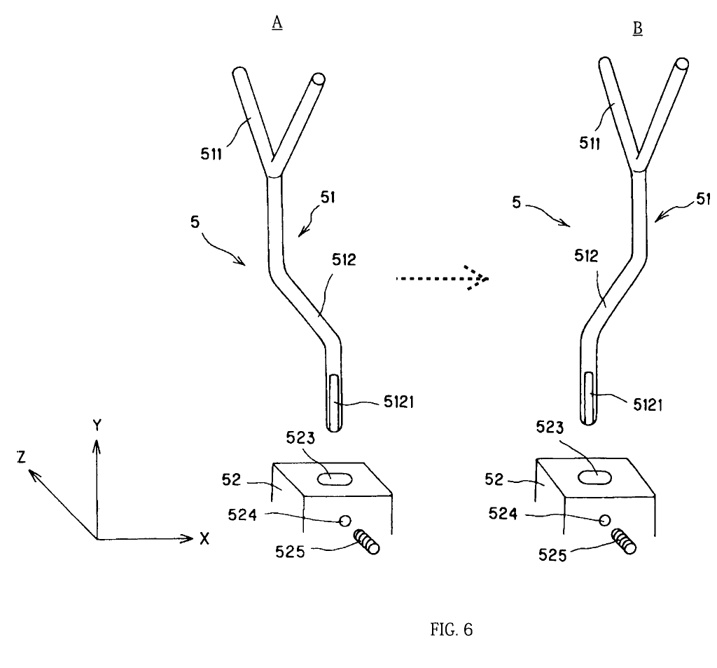

Next, a first lamp support member 5 according to a fourth embodiment used for a light source apparatus 1 is described, referring to FIG. 6.

A of FIG. 6 is a perspective view of a first lamp support member 5 according to the embodiment, in which a lamp support portion 51 is pulled out from a support stand 52. B of FIG. 6 is a perspective view of the first lamp support member 5, in which the lamp support portion 51 shown in A of FIG. 6 is rotated by 180 degrees around the Y axis. In the figure, flat sections 5121 are provided at both sides which are perpendicular to the Z axis direction of a lower end portion of an axis portion 512 of the lamp support portion 51, and the axis portion 512 is inserted in a hole section 523 which is provided in an upper face of the support stand 52, and further a hole section 524 for a fixing tool 525 is formed in a side face of the support stand 52. In addition, since the other structural elements in the figure, having the same reference numerals as those shown in FIG. 2 correspond to the same structural elements, explanation thereof is omitted.

In the first lamp support member 5 of this embodiment, as shown in A of FIG. 6, the tip of the axis portion 512 which has the flat sections 5121, is inserted in the hole section 523, and the fixing tool 525 is inserted in the hole 524 so as to engage the flat section 5121, thereby preventing it from coming off, and supporting and fixing the lamp support portion 51 to the support stand 52. Thereby, the lamp placement portion 511 is arranged in the first position in the optical axis direction.

When changing the position of the lamp placement portion 511 in the optical axis direction, the lamp support portion 51 shown in A of FIG. 6 is rotated by 180 degrees around the Y axis, so that the lamp support portion 51 is arranged as shown in B of FIG. 6. After that, the tip of the axis portion 512 is inserted in the hole section 523 of the support stand 52, and then the fixing tool 525 is inserted in the hole section 524 so as to engage the flat section 5121, thereby preventing it from coming off, and supporting and fixing the lamp support portion 51 to the support stand 52. Thereby, the lamp placement portion 511 is arranged in the second position in the optical axis direction. That is, since the axis portion 512 of the lamp support portion 51 is bent in the optical axis direction, by rotating the lamp support portions 51 by 180 degrees around the Y axis, the lamp placement portion 511 provided on the tip of the axis portion 512 is arranged in a position which is shifted in the X axis direction, whereby the xenon lamp 2 with a different length can be supported.

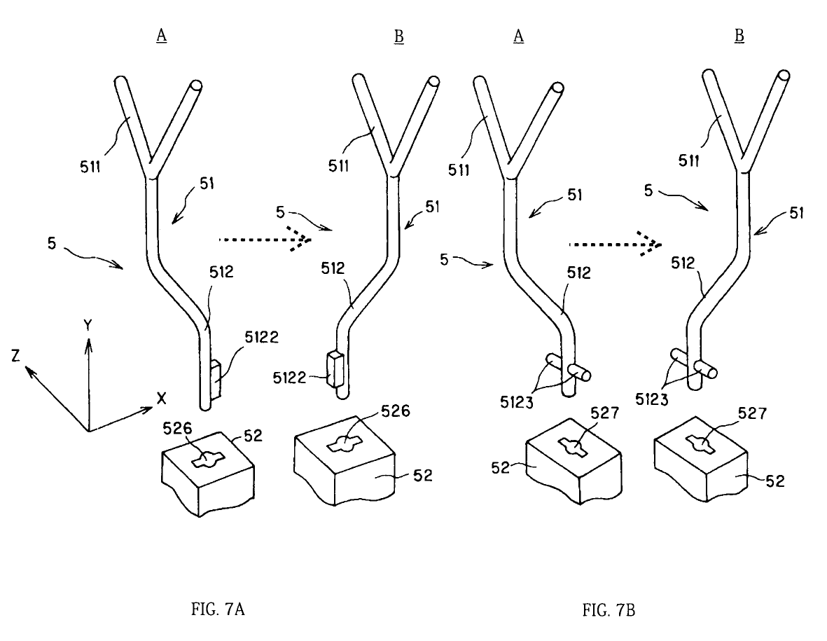

Next, a first lamp support member 5 according to a fifth embodiment used for a light source apparatus 1 is described, referring to FIG. 7.

A of FIG. 7A is a perspective view of a first lamp support member 5 according to this embodiment, in which a lamp support portion 51 is pulled out from a support stand 52. B of FIG. 7A is a perspective view of the first lamp support member 5 in which the lamp support portions 51 shown in A of FIG. 7A is rotated by 180 degrees around the Y axis. A of FIG. 7B is a perspective view of a first lamp support member 5 according to the embodiment, in which a lamp support portion 51 is pulled out from a support stand 52. B of FIG. 7B is a perspective view of the first lamp support member 5 in which the lamp support portion 51 shown in A of FIG. 7B is rotated by 180 degrees around the Y axis. In FIG. 7A, a projection portion 5122 is provided on a face of a lower end portion of an axis portion 512 of the lamp support portion 51 so as to project in the X axis direction. In FIG. 7B, projection portions 5123 are provided on both sides of a lower end portion of an axis portion 512 of the lamp support portion 51 so as to project in the Z axis direction. In FIG. 7A, only in two positions around the Y axis, the lower end portion of the axis portion 512 which has the projection portion 5122 can be inserted in a hole section 526 provided in an upper face of the support stand 52. In FIG. 7B, only in two positions around the Y axis, the lower end portion of the axis portion 512 which has the projection portions 5123 can be inserted in the hole section 527 provided in an upper face of the support stand 52. In addition, since the other structural elements in the figures having the same reference numerals as those shown in FIG. 2 correspond to the same structural elements in FIG. 2, explanation thereof is omitted.

In the first lamp support member 5 according to this embodiment, as shown in A of FIG. 7A, since the lower end portion of the axis portion 512 which has the projection portion 5122 is inserted in the hole section 526 of the support stand 52, the lamp placement portion 511 is placed in the first position in the optical axis direction.

When changing the position of the lamp placement portion 511 in the optical axis direction, the lamp support portions 51 shown in A of FIG. 7A is rotated around the Y axis by 180 degrees, whereby the lamp support portion 51 is arranged as shown in B of FIG. 7A. Then, the lamp placement portion 511 is arranged in the second position in the tube axis direction by inserting the lower end portion of the axis portion 512 which has the projection portion 5122, in the hole section 526 of the support stand 52.

Similarly, as shown in A of FIG. 7B, the lamp placement portion 511 is arranged in the first position in the tube axis direction by inserting the lower end portion of the axis portion 512 which has the projection portion 5123, in the hole section 527 of the support stand 52.

When changing the position of the lamp support portion 51 in the optical axis direction, the lamp support portions 51 shown in A of FIG. 7B is rotated by 180 degrees around the Y axis, whereby the lamp support portion 51 is arranged as shown in B of FIG. 7B. Then, the lamp placement portion 511 is arranged in the second position in the optical axis direction by inserting the lower end portion of the axis portion 512 which has the projection portion 5123 in the hole section 527 of the support stand 52. That is, since the axis portion 512 of the lamp support portion 51 is bent in the optical axis direction, by rotating the lamp support portions 51 by 180 degrees around the Y axis, the lamp placement portion 511 provided in the tip of the axis portion 512 is arranged in the position which is shifted in the X axis direction, so that it is possible to support the xenon lamp 2 with a different length.

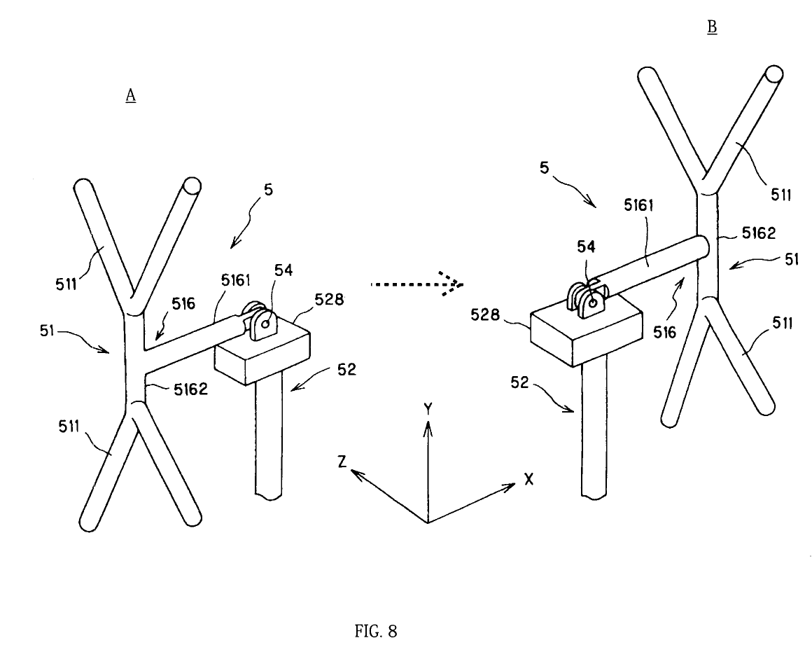

Next, a first lamp support member 5 according to a sixth embodiment used for a light source apparatus 1 is described, referring to FIG. 8.

A of FIG. 8 is a perspective view of a first lamp support member 5 according to this embodiment. B of FIG. 8 is a perspective view of the first lamp support member 5 in a state where a lamp support portions 51 shown in A of FIG. 8 is rotated by 180 degrees around the Z axis. In the figure, an axis portion 516 is T-shaped, and is rotatably supported by a hinge 54 on a stopper stand 528 of a support stand 52 at one end of a horizontal-axis section 5161. The other end of a horizontal axis section 5161 is connected to a portion which is approximately located in a middle of a vertical axis portion 5162. In the axis portion 5162, lamp placement portions 511 are provided at both ends of the vertical axis portion 5162, respectively. The support stand 528 is provided on an upper part of the support stand 52. The hinge 54 rotatably supports the axis portion 516 around the Z axis on the support stand 52. In addition, in a settled state, since the vertical axis portion 5161 of the axis portion 516 is abutted on the upper face of the stopper stand 528, so that rotation of the vertical axis portion 5161 is restricted. Moreover, since the other structural elements in the figure, having the same reference numerals as those shown in FIG. 2, correspond to the same structural elements of FIG. 2, explanation thereof is omitted.

Since in the first lamp support member 5 according to this embodiment, as shown in A of FIG. 8, the horizontal axis section 5161 of the axis portion 516 is in contact with and supported by the upper face of the stopper stand 528 of the support stand 52, one of the lamp placement portions 511 which is provided on the tip of the vertical axis portion 5162 is located at a first position in the X axis direction.

In A of FIG. 8, when changing the position of the lamp placement portion 511 in the X axis direction, the lamp support portions 51 is rotated by 180 degrees around the Z axis with respect to the hinge 54, whereby the lamp support portion 51 is arranged as shown in B of FIG. 8. As for the axis portion 516, since the vertical axis portion 5161 is again brought in contact with the upper face of the stopper stand 528 of the support stand 52, the other lamp placement portion 511 which is provided in the other tip of the vertical axis portion 5162 is arranged in a second position in the X axis direction. That is, since the axis portion 516 of the lamp support portion 51 has the horizontal axis section 5161 extending in the X axis direction, the vertical axis portion 5161 turns to a counter direction on the X axis direction line, by rotating the lamp support portion 51 by 180 degrees around the Z axis, so that the other lamp placement portion 511 provided in the tip of the horizontal axis section 5161 is rotated so as to be arranged in the second position which is shifted in the X axis direction from the first position at which the lamp placement portion was positioned, whereby the xenon lamp 2 with a different length can be supported.

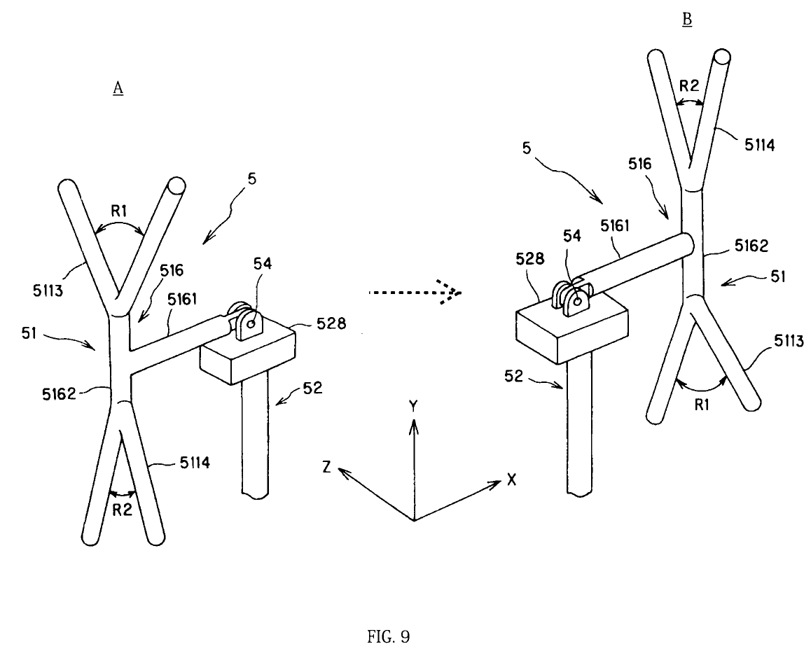

Next, a first lamp support member 5 according to a seventh embodiment used for a light source apparatus 1 is described, referring to FIG. 9.

A of FIG. 9 is a perspective view of the first lamp support member 5 according to this embodiment. B of FIG. 9 is a perspective view of the first lamp support member 5 in a state where a lamp support portions 51 shown in A of FIG. 9 is rotated by 180 degrees around the Z axis. In the figure, a first lamp placement portion 5113 has a V shaped section which is provided in one of the tips of the vertical axis portion 5162, and the opening angle of the V shaped section is R1. A second lamp placement portion 5114 has a V shaped section which is provided on the other tip of the vertical axis portion 5162, in which the opening angle of the V shaped section is R2. In addition, since the other structural elements of the figure, having the same reference numerals as those shown in FIGS. 2 and 8, correspond to the same structural elements of FIGS. 2 and 8, explanation thereof is omitted.

As shown in A of FIG. 9, in the first lamp support member 5 according to this embodiment, since a vertical axis portion 5161 of an axis portion 516 is brought in contact with an upper face of a stopper stand 528, the first lamp placement portion 5113 provided in the tip of the vertical axis portion 5162 is located at the first position in the X axis direction.

When changing the position of the lamp placement portion in the X axis direction, in A of FIG. 9, the lamp support portions 51 is rotated by 180 degrees around the Z axis with respect to a hinge 54, whereby the lamp support portion 51 is arranged as shown in B of FIG. 9. Thereby, as to the axis portion 516, since the horizontal axis portion 5161 is again brought into contact with the upper face of the stopper stand 528, the second lamp placement portion 5114 which is provided on the tip of the vertical axis portion 5162 faces up and is arranged in the second position in the X axis direction. That is, since the axis portion 516 of the lamp support portion 51 has the horizontal axis portion 5161 extending in the X axis direction, by rotating the lamp support portions 51 by 180 degrees around the Z axis, the horizontal axis portion 5161 turns to a counter direction on the X axis direction, and the second lamp placement portion 5114 provided on the tip of the vertical axis portion 5162 is arranged in the second position which is shifted in the X axis direction from the first position at which the first lamp placement portion 5113 was located before the rotation, whereby the xenon lamp 2 with a different length can be supported.

Moreover, in the first lamp support member 5 according to this embodiment, although the diameter of the mouthpieces 24 and 25 is small when the length of the xenon lamp 2 in the optical axis direction is short, by making the opening angle R2 of the V shaped section of the second lamp placement portion 5114 which supports the short xenon lamp 2 smaller than the opening angle R1 of the V shaped section of the first lamp placement portion 5113, it is possible to prevent the focal point of the xenon lamp 2 from shifting in the Y axis direction with respect to the focal point of the reflection mirrors 3 and 4 of the light source apparatus 1 shown in FIG. 1.

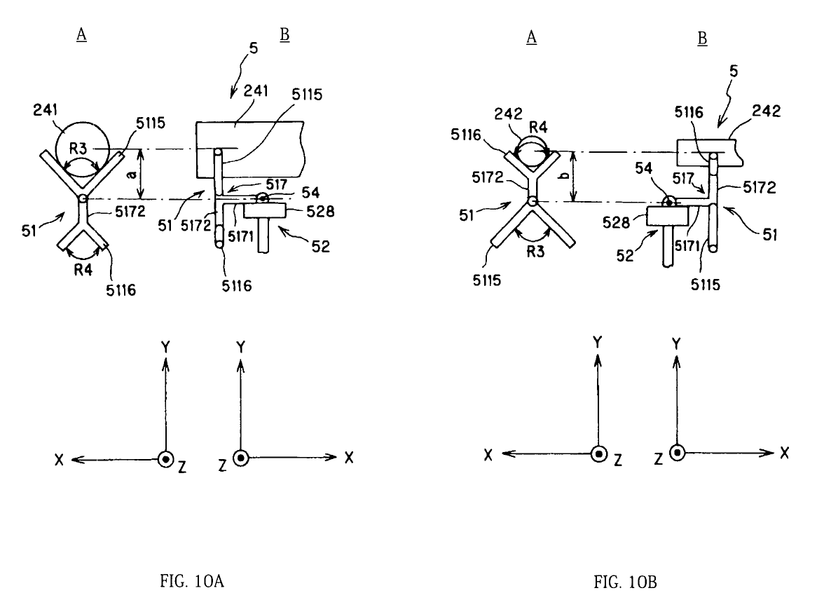

Next, a first lamp support member 5 according to an eighth embodiment used for the light source apparatus 1 is described, referring to FIGS. 10A and 10B.

A of FIG. 10A is a side elevational view of the first lamp support member 5 according to the embodiment. B of FIG. 10A is a front view of the first lamp support salary 5 shown in A of FIG. 10A. A of FIG. 10B is a side elevational view of the first lamp support member 5, in which a lamp support portion 51 shown in A of FIG. 10A is rotated by 180 degrees around the Z axis. B of FIG. 10B is a front view of the first lamp support member 5 shown in A of FIG. 10B. In these figures, a first lamp placement portion 5115 has a V shaped portion whose opening angle is R3, and the V shaped section extends in the Y axis direction from a bending section between a horizontal axis portion 5171 and a vertical axis portion 5172. A second lamp placement portion 5116 has a V shaped section provided on the tip of a vertical axis portion 5172, and the opening angle of the V shaped section is R4. An axis portion 517 is L-shaped, and has the horizontal axis portion 5171 extending in the X axis direction, and the vertical axis portion 5172 extending in the Y axis direction. One end of the horizontal axis portion 5171 is rotatably supported by a hinge 54 on a stopper stand 528 of a support stand 52, and the other end thereof is connected to the vertical axis portion 5172 which bends approximately in a right angled direction (the Y axis direction). One end of the vertical axis portion 5172 is connected to the horizontal axis portion 5171, and the second lamp installation 5116 which extends in the Y axis direction, is provided at the other end of the vertical axis portion 5172. Here, a reference numeral “a” is a distance between the central axis of the vertical axis portion 5171, and the central axis of the mouthpiece 241 placed on the first lamp placement portion 5115. A reference numeral “b” is a distance between the central axis of the horizontal axis portion 5171 and the central axis of the mouthpiece 242 whose diameter is different from that of the mouthpiece 241 placed on the second lamp placement portion 5115. The distance “a” and the distance “b” are set so as to be the same. In addition, since the other structural elements in the figures, having the same reference numerals as those shown in FIGS. 2 and 9, correspond to the same structural elements of FIGS. 2 and 9, explanation thereof is omitted.

In the first lamp support member 5 according to this embodiment, as shown in FIG. 10A, the horizontal axis portion 5171 of the axis portion 517 is brought into contact with an upper face of the stopper stand 528. One of mouthpieces 241 of the xenon lamp 2 can be placed on the first lamp placement portion 5115 having the V shaped section whose opening angle is R3 and which is formed in the Y axis direction from the other end of the horizontal axis portion 5171, whereby the first lamp placement portion 5115 is arranged in the first position in the X axis direction.

When changing the position of the lamp placement portion in the X axis direction, in FIG. 10A, the axis portion 517 is rotated by 180 degrees around the Z axis with respect to the hinge 54, so that the lamp support portion 51 is arranged, as shown in FIG. 10B. While the horizontal axis portion 5171 of the axis portion 517 is again brought into contact with the upper face of the stopper stand 528 so that the second lamp placement portion 5116 is arranged in the second position in the X axis direction, the mouthpiece 242 whose diameter is different from that of the mouthpiece 241 can be arranged in the second lamp placement portion 5116 which has the V shaped section having the opening angle R4, and is formed on the tip of the vertical axis portion 5172. That is, since the axis portion 517 of the lamp support portion 51 has the horizontal axis portion 5171 extending in the X axis direction, the horizontal axis portion 5171 is turned to a counter direction on an X axis direction line, by rotating the lamp support portion 51 by 180 degrees around the Z axis, the second lamp placement portion 5116 is rotated so that the position thereof is shifted in the X axis direction from the previous position of the first lamp placement portion 5115, whereby the xenon lamp 2 having a different length can be supported thereby. Furthermore, when the distance “a” and the distance “b” are the same, even if the mouthpiece 24 of the xenon lamp 2 having a different diameter is used, it is possible to prevent the xenon lamp 2 from shifting in the Y axis direction.

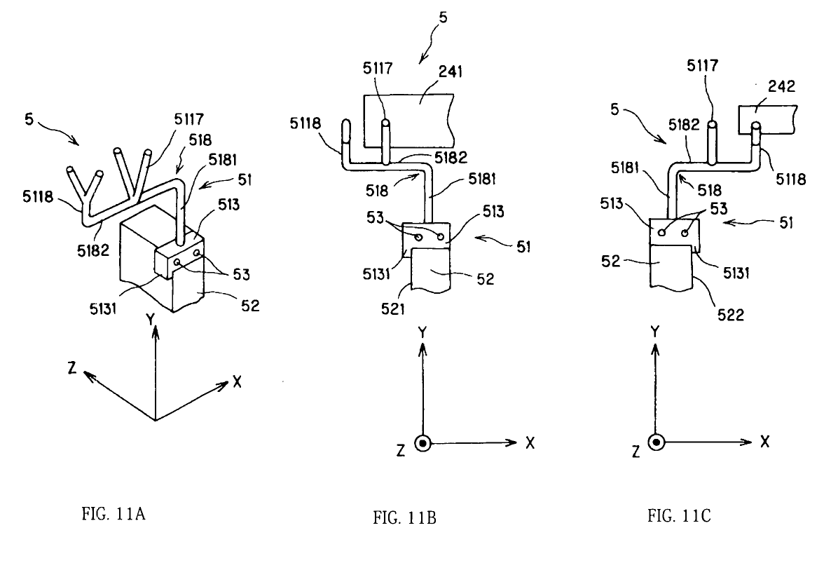

Next, a first lamp support member 5 according to a ninth embodiment used for a light source apparatus 1 is described, referring to an FIGS. 11A, 11B and 11C. FIG. 11A is a perspective view of a first lamp support member 5 according to this embodiment. FIG. 11B is a front view of the first lamp support member 5 shown in the FIG. 11A. FIG. 11C is a front view of the first lamp support member 5 in which the lamp support portions 51 shown in the FIG. 11A is rotated by 180 degrees around the Y axis. In these figures, a first lamp placement portion 5117 is V-shaped and extends from a middle part of the vertical axis portion 5182 of an axis portion 518 in the Y axis direction approximately, and the second lamp placement portion 5118 is Y-shaped and extends in the Y axis direction from an end portion of the horizontal axis portion 5182 of the axis portion 518. The axis portion 518 is L-shaped and has the vertical axis portion 5181 which extends in the Y axis direction, and the horizontal axis portion 5182 which extends in the X axis direction. The vertical axis portion 5181 whose lower end portion is fixed to a positioning stand 513, and whose upper end portion bends in the X axis direction, is connected to the horizontal axis portion 5182. The horizontal axis portion 5182 is connected to the vertical axis portion 5181 which extends in the Y axis direction. The first lamp placement portion 5117 is supported approximately at a middle portion of the horizontal axis portion 5182. The second lamp placement portion 5118 is supported at the other end of the horizontal axis portion 5182. In addition, since the other structural elements in the figures, having the same reference numerals as those shown in FIG. 2, correspond to the same structural elements of FIG. 2, explanation thereof is omitted.

In the first lamp support member 5 according to this embodiment, as shown in FIG. 11B, a first face 521 of the support stand 52 engages an inner face of a projection portion 5131 of the positioning stand 513 of a lamp support portion 51, and the positioning stand 513 is fixed to the support stand 52 by a fixing member 53, whereby a mouthpiece 241 of the xenon lamp 2 can be placed on the first lamp placement portion 5117 provided on the axis portion 518 fixed to the positioning stand 513, and the first lamp placement portion 5117 is arranged in the first position in the X axis direction.

When changing the position of the X axis direction of the lamp placement portion, the fixing member 53 is removed, the positioning stand 513 which supports the axis portion 518 of the lamp support portion 51 is rotated by 180 degrees around the Y axis, and as shown in FIG. 1C, the projection portion 5131 of the positioning stand 513 is arranged so as to engage the second face 522 of the support stand 52, and the positioning stand 513 is fixed to the support stand 52 by the fixing member 53. Thereby, while the second lamp placement portion 5118 is arranged in the second position in the X axis direction, the xenon lamp which has a mouthpiece 242 with a short tube-axis length and with a diameter smaller than that of the mouthpiece 241 can be placed in the second lamp placement portion 5118. That is, since the axis portion 518 of the lamp support portion 51 has the horizontal axis portion 5182 extending in the X axis direction, the horizontal axis portion 5182 is turned to a counter direction on an X axis direction line by rotating the lamp support portion 51 by 180 degrees around the Y axis, and the second lamp placement portion 5118 is arranged in the position which is shifted in the X axis direction with respect to the first lamp placement portion 5117, so that a different length of the xenon lamps 2 can be supported thereby.

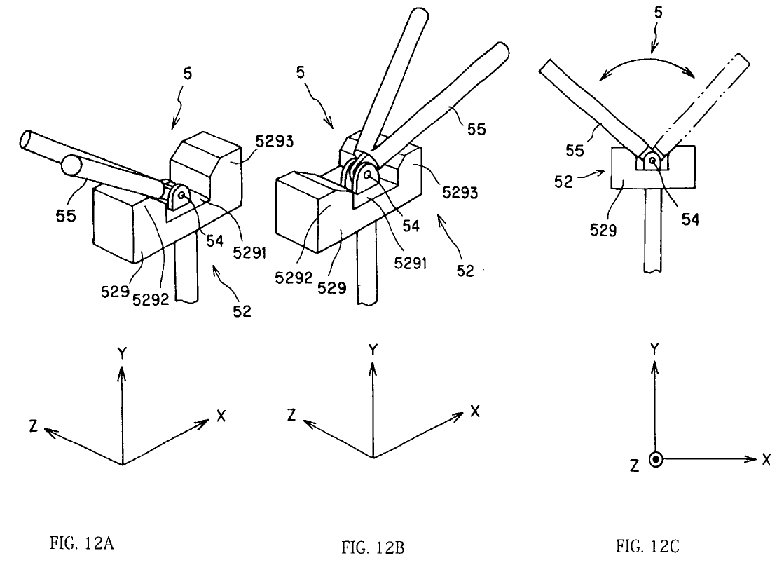

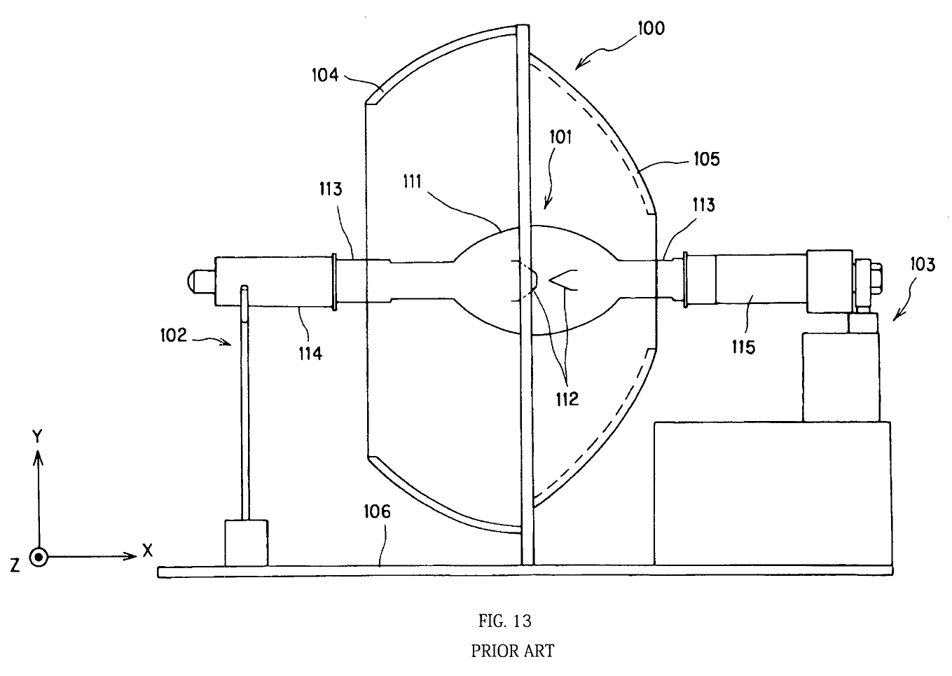

Next, a first lamp support member 5 according to a tenth embodiment used for the light source apparatus 1 is described, referring to an FIGS. 12A, 12B and 12C.

FIG. 12A is a perspective view of the first lamp support member 5 according to the embodiment. FIG. 12B is a perspective view of the first lamp support member 5 in which a lamp support portion 55 shown in FIG. 12A is rotated around the Z axis. FIG. 12C is a front view showing a rotation operation of the lamp support portion 55 of the first lamp support member 5 shown in an FIGS. 12A and 12B.

In these figures, the lamp support portion 55 is V-shaped and the bottom of the V-shaped section is rotatably supported by a hinge 54 on the stopper stand 529 of a support stand 52. An upper face of the stopper stand 529 has a concave portion, is equipped with a hinge 54 which rotatably supports the lamp support portion 55 around the Z axis at a bottom 5291, and restricts rotation thereof by bringing the lamp support portion 55 into contact with a projection portion 5292 or 5293 arranged in the X axis direction. The bottom 5291 is formed on the stopper stand 529 and the hinge 54 is provided thereon. Rotation of the lamp support section 55 is restricted by bringing it into contact with the projection 5292 or 5293, while inclining and arranging the lamp support portion 55 in the X axis direction.

In the first lamp support member 5 according to this embodiment, as shown in FIG. 12A, the lamp support portion 55 is arranged in the first position in the X axis direction in a state where the lamp support portion 55 is in contact with the projection portions 5292 provided on the stopper stand 529, and inclines in the X axis direction.

When changing the position of the lamp support portion 52 in the X axis direction, in FIG. 12A, the lamp support portion 55 is rotated by, for example, 90 degrees around the Z axis with respect to the hinge 54, so that the lamp support portion 52 is arranged so as to be inclined as shown in an FIG. 12B. Thereby, the lamp support portion 55 is arranged in a second position in the X axis direction in a state where the lamp support portion 55 is in contact with the other projection portion 5293 of the stopper stand 529, and inclines in the counter direction with the above-mentioned inclination in the X axis direction. That is, by rotating, around the Z axis, the lamp support portion 55 which was arranged so as to be inclined, the lamp support portion 55 is arranged in the position which inclines in the counter direction with the inclination direction and is shifted in the X axis direction, whereby the xenon lamps 2 with a different length can be supported thereby.

The preceding description has been presented only to illustrate and describe exemplary embodiments of the light source apparatus according to the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A light source apparatus comprising:
a reflection mirror;
a first support member which supports a first mouthpiece of a xenon lamp;
a second support member which supports a second mouthpiece of the xenon lamp;
a support plate which supports the reflection mirror and the first and second mouthpieces;
wherein the first lamp support member has a lamp support portion, and a support stand which is supported by the support plate and supports the lamp support portion, and
wherein the lamp support portion is capable of selectively changing a position of the first support member between two positions in an optical direction.

2. The light source apparatus according to claim 1, wherein the lamp support portion has a lamp placement portion, an axis portion which supports the lamp placement portion and bends in the optical axis direction, and a positioning stand which supports the axis portion and is supported by the support stand, and wherein a direction of the positioning stand is capable of being rotated in the optical axis direction by 180 degrees.

3. The light source apparatus according to claim 1, wherein the lamp placement portion is formed in a shape of approximately a V symbol, U symbol or a symbol.

4. The light source apparatus according to claim 1, wherein the lamp support portion has a lamp placement portion, an axis portion which supports the lamp placement portion, and a positioning stand which supports the axis portion which is shifted in the optical axis direction and is supported by the support stand, and wherein a direction of the positioning stand is capable of being rotated in the optical axis direction by 180 degrees.

5. The light source apparatus according to claim 1, wherein the lamp support portion has a lamp placement portion, an axis portion which supports the lamp placement portion, is shifted in the optical axis direction, and has an engagement portion, wherein the support stand has a hole in which the axis portion is inserted, wherein the hole has a shape by which a direction of the axis portion is determined when the engagement portion of the axis portion is inserted in the hole, and wherein a direction of the positioning stand is capable of being rotated in the optical axis direction by 180 degrees.

6. The light source apparatus according to claim 5, wherein the engagement portion is flat portions formed on a lower portion of the axis portion.

7. The light source apparatus according to claim 5, wherein the engagement portion is a projection.

8. The light source apparatus according to claim 5, wherein the engagement portion is two or more projections.

9. The light source apparatus according to claim 5, wherein the positioning stand is fixed to the support stand by a fixing tool.

10. The light source apparatus according to claim 1, wherein the lamp support portion has two lamp placement portions facing in directions which are opposite to each other, and are perpendicular to an optical axis, an axis portion which supports the two lamp placement portions, wherein the support stand has a stopper stand which restricts rotation of the axis portion and a hinge which rotatably supports the axis portion on a face perpendicular to the optical axis, and wherein the axis portion is capable of being rotated with respect to the hinge so that a direction of the axis portion is changed in the optical axis direction.

11. The light source apparatus according to claim 1, wherein the lamp support portion has two lamp placement portions, facing in a same direction which is perpendicular to the optical axis, and provided apart to each other in the optical axis direction, and an axis portion which supports the two lamp placement portions, and a positioning stand which supports the axis portion and which is supported by the support stand, wherein a direction of the positioning stand is capable of being rotated in the optical axis direction by 180 degrees.

12. The light source apparatus according to claim 10, wherein opening angles of the two lamp placement portions are different from each other.

13. The light source apparatus according to claim 11, wherein opening angles of the two lamp placement portions are different from each other.

14. The light source apparatus according to claim 1, wherein the support stand has a stopper stand which restricts rotation of the lamp support portion and a hinge which rotatably supports the lamp support portion on a face perpendicular to the optical axis, and wherein the lamp support portion is capable of being rotated with respect to the hinge so that a direction of the lamp support portion is changed in the optical axis direction.
